(19) United States
(12) Patent Application Publication
(10) Pub. No.: US 2016/0034991 A1
(43) Pub. Date: Feb. 4, 2016

(54) METHOD AND SYSTEM FOR IDENTIFICATION OF NONCOMPLIANT MERCHANTS

(71) Applicant: MasterCard International Incorporated, Purchase, NY (US)

(72) Inventor: Justin X. HOWE, San Francisco, CA (US)

(73) Assignee: MASTERCARD INTERNATIONAL INCORPORATED, Purchase, NY (US)

(21) Appl. No.: 14/815,058

(22) Filed: Jul. 31, 2015

Related U.S. Application Data
(60) Provisional application No. 62/031,998, filed on Aug. 1, 2014.

(51) Int. Cl. G06Q 30/06; G06Q 30/00

(52) U.S. Cl. CPC G06Q 30/0609; G06Q 30/018

(57) ABSTRACT

A method for assessing merchant likelihood of noncompliance includes: storing a plurality of transaction data entries, each entry including data related to a payment transaction including transaction data, an account identifier, and a merchant identifier; identifying a first set of transaction data entries that include a specific merchant identifier associated with a merchant noncompliant with a rule or regulation; identifying a set of account identifiers from the transaction data entries in the first set; identifying a second set of transaction data entries that include account identifiers from the set of account identifiers; identifying a set of merchant identifiers from the transaction data entries in the second set; and calculating, for each merchant identifier in the set, a score indicative of a likelihood that an associated merchant is noncompliant with the rule or regulation based on the transaction data included in each of their transaction data entries in the second set.

### FIELD

The present disclosure relates to the identification of merchants as noncompliant, specifically the assessment of a merchant's likelihood of being noncompliant based on shared consumers and other transaction data with another merchant identified as being noncompliant.

### BACKGROUND

Merchants that are found to be in violation of a rule or regulation, such as due to the selling of counterfeit goods, selling of pirated or stolen goods, advertising via spam e-mail, etc., can often cause other merchants, retailers, and manufacturers to lose significant amounts of revenue. As a result, these victimized merchants, as well as regulatory agencies that enforce the violated rules and regulations, such as law enforcement agencies, industry groups, and other governmental and non-governmental entities, often go to great lengths to identify and shut down or correct the behavior of merchants in violation.

When a merchant selling counterfeit goods, such as counterfeit pharmaceuticals sold at a fraction of the price of their genuine counterparts, is shut down, their regular consumers may have to seek another merchant from which they can purchase their products. However, rather than buy the genuine product from the victimized merchant after their counterfeit provider is shut down, many consumers may instead seek out another counterfeiter. The victimized merchant and regulatory agencies must then repeat their entire investigative process to identify the new counterfeiting merchant and have them shut down as well.

Thus, there is a need for a technical system to more quickly and efficiently assess a merchant's likelihood of being noncompliant with a rule or regulation based on shared consumers and transaction data with another merchant previously found to be noncompliant with the rule or regulation.

### SUMMARY

The present disclosure provides a description of systems and methods for assessing merchant likelihood of noncompliance.

A method for assessing merchant likelihood of noncompliance includes: storing, in a transaction database, a plurality of transaction data entries, wherein each transaction data entry includes data related to a payment transaction including at least transaction data, an account identifier associated with a transaction account involved in the payment transaction, and a merchant identifier associated with a merchant involved in the payment transaction; identifying, in the transaction database, a first set of transaction data entries, wherein each transaction data entry in the first set includes a specific merchant identifier associated with a merchant identified as being noncompliant with a rule or regulation; identifying, by a processing device, a set of account identifiers, wherein each account identifier in the set is included in a transaction data entry included in the identified first set of transaction data entries; identifying, in the transaction database, a second set of transaction data entries, wherein each transaction data entry in the second set includes an account identifier included in the identified set of account identifiers and a merchant identifier other than the specific merchant identifier; identifying, by the processing device, a set of merchant identifiers, wherein each merchant identifier in the set is included in a transaction data entry included in the second set of transaction data entries; and calculating, for each merchant identifier in the identified set of merchant identifiers, a score indicative of a likelihood that a merchant associated with the respective merchant identifier is noncompliant with the rule or regulation based on at least the transaction data included in each transaction data entry in the identified second set of transaction data entries that includes the respective merchant identifier.

A system for assessing merchant likelihood of noncompliance includes a transaction database and a processing device. The transaction database is configured to store a plurality of transaction data entries, wherein each transaction data entry includes data related to a payment transaction including at least transaction data, an account identifier associated with a transaction account involved in the payment transaction, and a merchant identifier associated with a merchant involved in the payment transaction. The processing device is configured to: identify, in the transaction database, a first set of transaction data entries, wherein each transaction data entry in the first set includes a specific merchant identifier associated with a merchant identified as being noncompliant with a rule or regulation; identify a set of account identifiers, wherein each account identifier in the set is included in a transaction data entry included in the identified first set of transaction data entries; identify, in the transaction database, a second set of transaction data entries, wherein each transaction data entry in the second set includes an account identifier included in the identified set of account identifiers and a merchant identifier other than the specific merchant identifier; identify a set of merchant identifiers, wherein each merchant identifier in the set is included in a transaction data entry included in the second set of transaction data entries; and calculate, for each merchant identifier in the identified set of merchant identifiers, a score indicative of a likelihood that a merchant associated with the respective merchant identifier is noncompliant with the rule or regulation based on at least the transaction data included in each transaction data entry in the identified second set of transaction data entries that includes the respective merchant identifier.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for assessing merchant likelihood of noncompliance in accordance with exemplary embodiments.

FIG. 2 is a block diagram illustrating the processing server of FIG. 1 for assessing merchant likelihood of noncompliance in accordance with exemplary embodiments.

FIG. 3 is a block diagram illustrating the transaction database of the processing server of FIG. 2 for storing transaction data used in assessing merchant likelihood of noncompliance in accordance with exemplary embodiments.

FIGS. 4A-4D are diagrams illustrating the identification of shared consumers and transaction data used to assess the likelihood of noncompliance for merchants based on a noncompliant merchant in accordance with exemplary embodiments.

FIG. 5 is a flow chart illustrating an exemplary method for assessing merchant likelihood of noncompliance in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

### System for Assessing Merchant Likelihood of Noncompliance

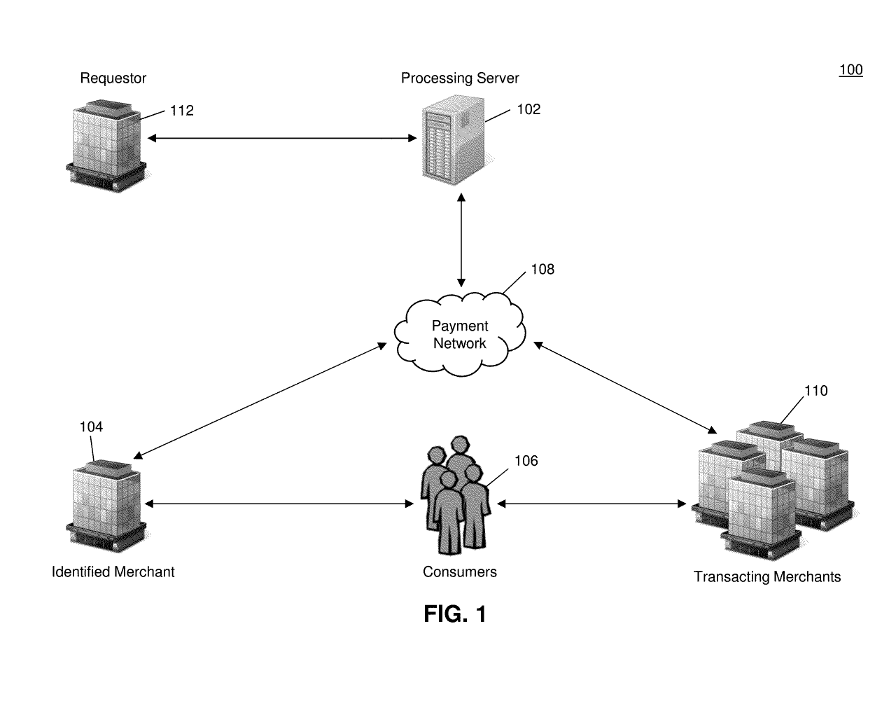

FIG. 1 illustrates a system 100 for the assessing of merchant likelihood of noncompliance based on shared consumers and transaction data with a merchant indicated as being noncompliant with a rule or regulation.

The system 100 may include a processing server 102. The processing server 102, discussed in more detail below, may be configured to assess merchant likelihood of noncompliance based on the sharing of consumers and similarity of transaction data with a merchant found to be noncompliant with a rule or regulation. The processing server 102 may identify a merchant 104 as being noncompliant with a rule or regulation. Methods and systems for identifying a merchant as being noncompliant with a rule or regulation will be apparent to persons having skill in the relevant art and may include the identification of a merchant as being associated with the distribution of spam messages as described in U.S. patent application Ser. No. 14/071,775, entitled “Method and System for Automated Detection of CAN-SPAM Violations by Merchants and Acquirers,” by Justin Xavier Howe, filed on Nov. 5, 2013, which is herein incorporated by reference in its entirety. In some embodiments, the merchant 104 may be identified by a third party, such as a regulatory agency that has found the merchant 104 to be in violation of a rule or regulation.

The processing server 102 may, as discussed in more detail below, be configured to identify a plurality of consumers 106 that conduct payment transactions with the identified merchant 104. The processing server 102 may identify the consumers 106 via transaction data for payment transactions that involve the identified merchant 104, which may be supplied by a payment network 108. The payment network 108 may be configured to process payment transactions involving the identified merchant 104. The payment network 108 may process the payment transactions and may transmit data associated with the transactions to the processing server 102 for storage in a transaction database, discussed in more detail below.

The payment network 108 may also process payment transactions for a plurality of transacting merchants 110. The transacting merchants 110 may be merchants other than the identified merchant 104 with whom the consumers 106 also transact. The payment network 108 may process the payment transactions that involve the transacting merchants 110 and provide the data to the processing server 102 for storage in the transaction database. Methods and systems for the processing of payment transactions by the payment network 108 will be apparent to persons having skill in the relevant art.

The processing server 102 may identify the consumers 106 that are involved in payment transactions with the identified merchant 104, and then identify the transacting merchants 110 that are involved in payment transactions with the identified consumers 106 based on the transaction data received from the payment network 108. Once the transacting merchants 110 are identified, the processing server 102 may assess each transacting merchant's 110 likelihood of being noncompliant with the same rules and regulations that the identified merchant 104 was found to be noncompliant with based on the transaction data for the payment transactions involving the consumers 106 that each transacting merchant 110 has in common with the identified merchant 104.

For example, the consumers 106 may regularly purchase counterfeit pharmaceuticals from the identified merchant 104 with the transaction amounts falling within a specific range. When the identified merchant 104 is shut down, the consumers 106 may start purchasing the counterfeit pharmaceuticals from one or more transacting merchants 110. The processing server 102 may identify transacting merchants 110 with whom the consumers 106 transact following the date that the identified merchant 104 is shut down and with whom the transaction amounts are within or near the specific range. The similarity in transaction amounts, as well as the timing of the purchases, may indicate a high likelihood that the transacting merchant 110 is also selling the counterfeit pharmaceutical and thus noncompliant with the relevant rule or regulation.

Additional data that the processing server 102 may consider to assess the likelihood of noncompliance may include merchant category codes or industry codes, product identifiers, product names, product descriptions, product data, transaction times and/or dates, geographic locations, payment method, payment type, etc. The processing server 102 may assess each transacting merchant's 110 likelihood of noncompliance based on analysis of the transaction data for payment transactions involving the consumers 106 and the identified merchant 104.

For instance, the processing server 102 may assess a transacting merchant 110 as having a higher likelihood of being noncompliant if the geographic location data for transactions indicates the transactions as being cross-border transactions. For example, pharmaceuticals bought in the United States from a vendor in a foreign country may indicate a higher likelihood that the purchase is for counterfeit goods and thus in noncompliance with a rule or regulation. In another example, purchase frequency may indicate a likelihood of noncompliance. For instance, if the consumers each 106 transacted with the identified merchant 104 once a month every month, and once the identified merchant 104 was shut down, transacted with a particular transacting merchant 110 once a month, but other merchants more regularly, the processing server 102 may assess the particular transacting merchant 110 as having a higher likelihood of noncompliance than the other merchants, as the pattern may indicate that the consumers 106 are purchasing noncompliant products from the particular transacting merchant 110 in place of the identified merchant 104.

In some embodiments, the assessment may be performed via the calculation of a score for the transacting merchant 110. The score may represent the likelihood of the transacting merchant's 110 noncompliance, and may be represented as a numerical value, such as a number on a scale from 1 to 100, with a higher number indicating a higher likelihood of noncompliance.

In some instances, the system 100 may include a requestor 112. The requestor 112 may be a victimized merchant, regulatory agency, or other entity that requests identification and assessment of transacting merchants 110 for an identified merchant 104. The requestor 112 may provide data identifying the identified merchant 104 to the processing server 102. The processing server 102 may then identify the transacting merchants 110 that are using methods and systems discussed herein and may assess the likelihood that each transacting merchant 110 is noncompliant. The processing server 102 may then provide the assessments to the requestor 112. In some embodiments, the processing server 102 may first filter the transacting merchants 110 to obtain those transacting merchants 110 with a high likelihood of noncompliance, such as by filtering out transacting merchants 110 whose calculated score is below a predefined value. The requestor 112 may then use the received list as a tool to guide further investigation into noncompliance with the rules and regulations.

In some instances, the requestor 112 or other third party may also include one or more consumers 106 whose transactions are to be excluded from the assessment. For instance, the requestor 112 may identify consumers 106 that are undercover investigators purchasing counterfeit goods as part of an investigation, and thus do not have purchases with other noncompliant merchants. In some embodiments, the processing server 102 may include transactions associated with an indicated consumer 106 and use the information in calculating the likelihood of a transacting merchant 110. For example, if a consumer 106 is identified as an undercover investigator that is investigating the identified merchant 104, and also has purchases at a transacting merchant 110, it may represent that the transacting merchant 110 has a low likelihood of being noncompliant if the investigator is transacting regularly at the transacting merchant 110 outside of their official capacity.

By identifying transacting merchants 110 that have consumers 106 in common with an identified merchant 104 that is found to be noncompliant with a rule or regulation, the processing server 102 may be able to quickly identify merchants that may also be noncompliant with the rule or regulation. In addition, by also analyzing the transaction data for transactions conducted with the consumers 106 in common, and comparing the transaction data to the transactions conducted between the consumers 106 and the identified merchant 104, the processing server 102 may be able to provide an accurate assessment of a transacting merchant's 110 likelihood of being noncompliant. This information may be beneficial for victimized merchants and regulatory agencies as it may quickly and effectively identify merchants for investigation in instances where consumers 106 may go from one noncompliant merchant to another.

### Processing Server

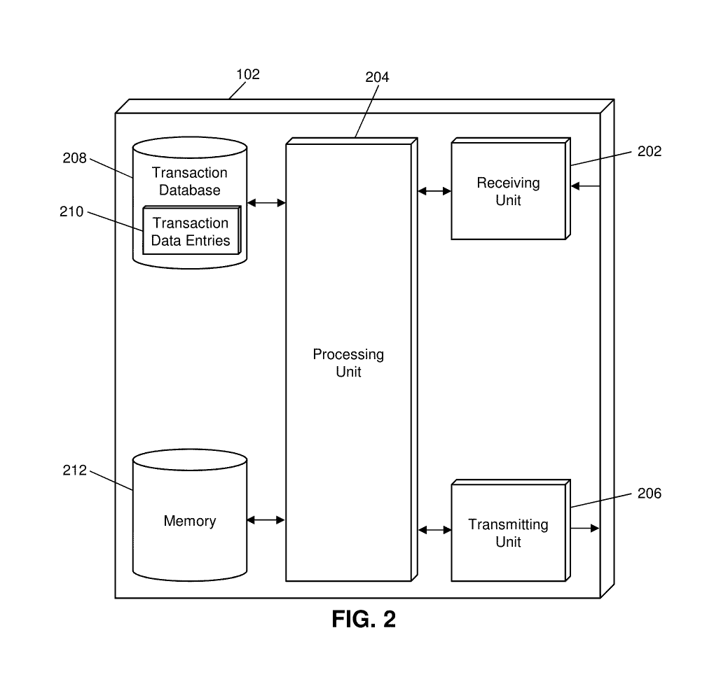

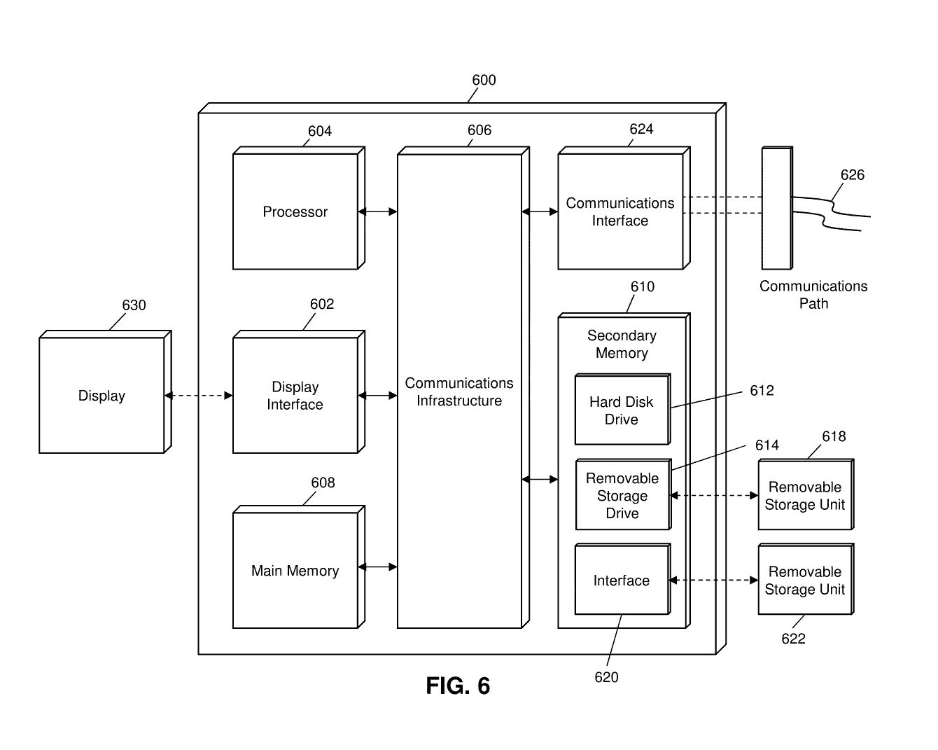

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive transaction data from the payment network 108 for a plurality of payment transactions. The receiving unit 202 may also be configured to receive requests from a requestor 102 for merchants 110 and/or scores based on assessments of merchant likelihood of noncompliance. Request received by the receiving unit 202 may include at least a merchant identifier associated with an identified merchant 104, and may also include one or more rules used for filtering a list of transacting merchants 110.

The processing server 102 may also include a processing unit 204. The processing unit 204 may be configured to perform the functions of the processing server 102 discussed herein as will be apparent to persons having skill in the relevant art. The processing unit 204 may store the received transaction data in a transaction database 208 as a plurality of transaction data entries 210. As discussed in more detail below, each transaction data entry 210 may be configured to store data related to a payment transaction including a merchant identifier, account identifier, and other transaction data.

The processing unit 204 may be configured to identify transaction data entries 210 in the transaction database 208 related to payment transactions involving the identified merchant 104. Transaction data entries 210 related to payment transactions involving the identified merchant 104 may include a merchant identifier associated with the identified merchant 104. The processing unit 204 may also be configured to then identify transaction accounts (e.g., associated with consumers 106) also involved in the payment transactions involving the identified merchant 104 based on account identifiers included in the identified transaction data entries. In some embodiments, the processing unit 204 may exclude specific transaction accounts, such as transaction accounts associated with undercover investigators.

Once the account identifiers have been identified, the processing unit 204 may identify transaction data entries 210 in the transaction database 208 that include the account identifier, and thus correspond to transactions involving the associated transaction accounts, and that include a merchant identifier other than the merchant identifier associated with the identified merchant 104. The result may therefore be payment transactions involving the consumers 106 that transacted with the identified merchant 104 and other transacting merchants 110. The merchant identifiers included in the newly identified transaction data entries 210 may therefore correspond to the transacting merchants 110.

The processing unit 204 may be further configured to then calculate a score indicative of the likelihood that the transacting merchant 110 is noncompliant with the rule or regulation. The score may be calculated based on the transaction data included in the newly identified transaction data entries and the transaction data included in the initially identified transaction data entries related to payment transactions involving the identified merchant 104. In some instances, transaction data entries that involve a common transaction account may be compared as part of the calculation of the score.

In some embodiments, the processing unit 204 may be configured to filter the transacting merchants 110 based on the calculated score. For instance, the processing unit 204 may filter out any transacting merchants 110 whose calculated score is below a predefined value. In some cases, the predefined value may be included in a request received by the receiving unit 202 from the requestor 112.

The processing server 102 may also include a memory 212. The memory 212 may be configured to store data suitable for performing the functions discussed herein. For example, the memory 212 may store one or more algorithms used by the processing unit 204 in calculating the score, one or more filtering rules, one or more predefined values used in filtering or assessing merchant noncompliance, rules for the matching of transaction data entries for assessment, and other data that will be apparent to persons having skill in the relevant art.

The processing server 102 may further include a transmitting unit 206. The transmitting unit 206 may be configured to transmit data over one or more networks via one or more network protocols. The transmitting unit 206 may transmit the calculated scores to the requestor 112 in response to the request received by the receiving unit 202. In embodiments where the transacting merchants 110 may be filtered, the transmitting unit 206 may transmit the filtered transacting merchants 110. In some instances, the transmitting unit 206 may be configured to transmit merchant identifiers associated with the transacting merchants 110 in place of the calculated scores. In other instances, the transmitting unit 206 may be configured to transmit merchant identifiers and calculated scores for the transacting merchants 110.

### Transaction Database

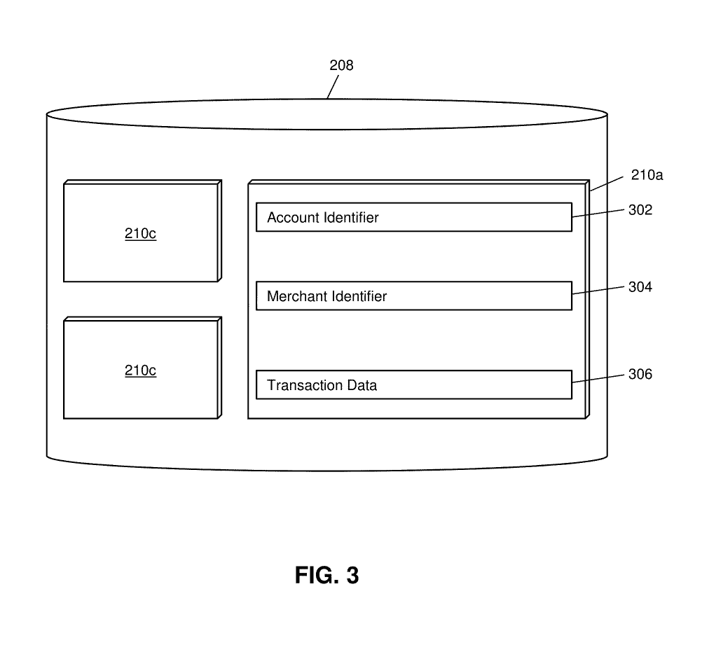

FIG. 3 illustrates the transaction database 208 of the processing server 102 configured to store transaction data for a plurality of payment transactions.

The transaction database 208 may be configured to store a plurality of transaction data entries 210, illustrated in FIG. 3 as transaction data entries 210a, 210b, and 210c. Each transaction data entry 210 may include data related to a payment transaction and may include at least an account identifier 302, a merchant identifier 304, and transaction data 306.

The account identifier 302 may be a unique value associated with a transaction account involved in the related payment transaction (e.g., associated with a consumer 106 and used to fund the payment transaction). The account identifier 302 may be a transaction account number, reference number, controlled payment number, username, phone number, e-mail address, device identifier, or other suitable value that will be apparent to persons having skill in the relevant art.

The merchant identifier 304 may be a unique value associated with a merchant involved in the related payment transaction, such as the identified merchant 104 or a transacting merchant 110. The merchant identifier 304 may be a merchant identification number, reference number, transaction account number, acquirer identification number, point of sale identifier, or other suitable value that will be apparent to persons having skill in the relevant art.

The transaction data 306 may include additional data associated with the related payment transaction suitable for performing the functions disclosed herein. For example, the transaction data may include a transaction identifier, transaction amount, transaction time and/or date, geographic location, location identifier, payment method, payment type, payment details, product data, product identifier, product name, product quantity, product cost, product description, merchant name, merchant category code, merchant industry, industry code, manufacturer data, coupon data, loyalty data, and other data that will be apparent to persons having skill in the relevant art.

### Identification of Transacting Merchants

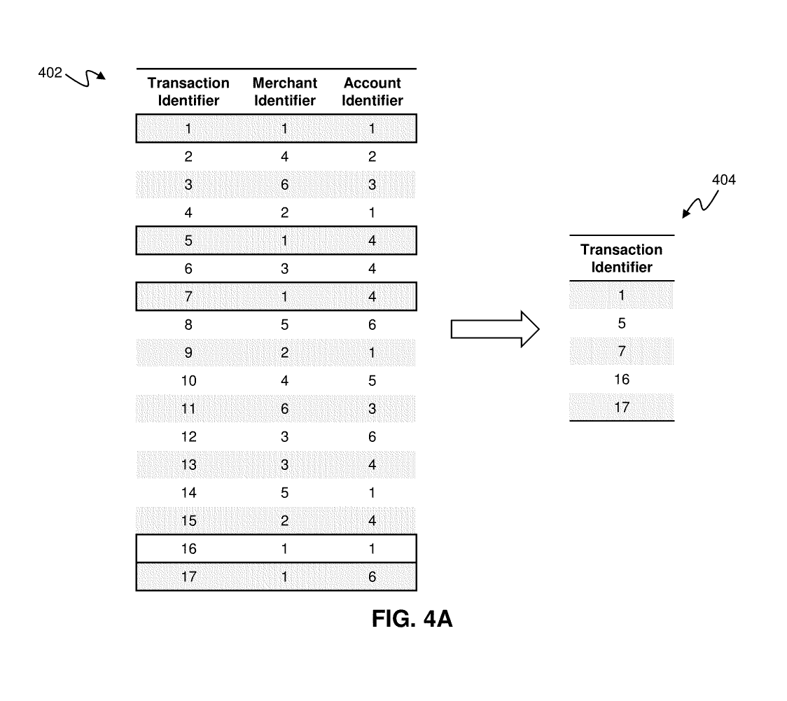

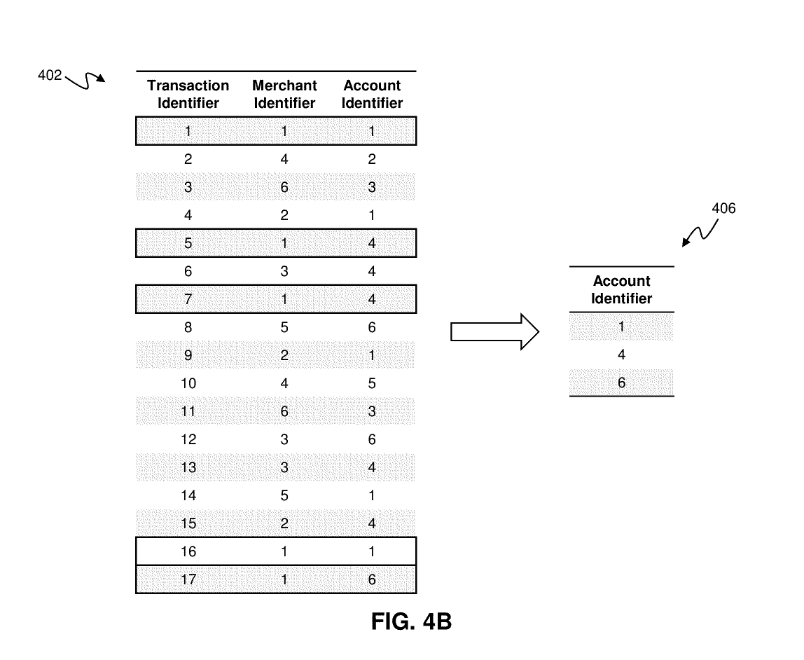

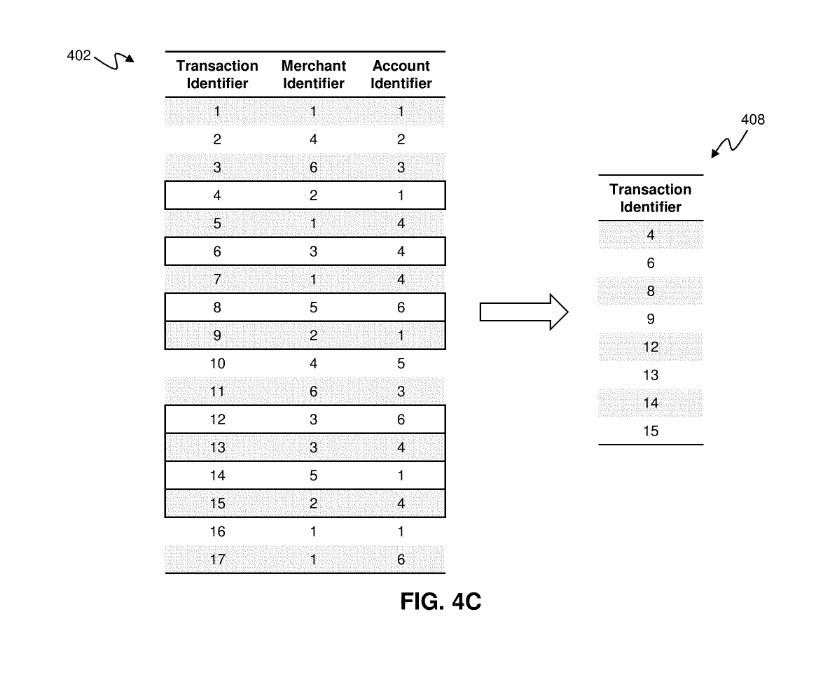

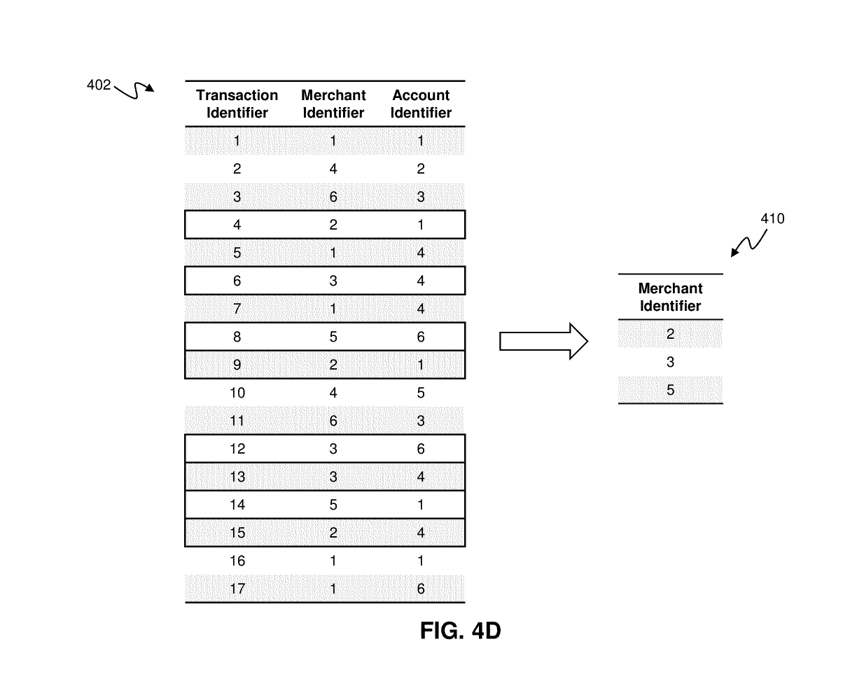

FIGS. 4A-4D illustrate the identification of transacting merchants 110 and transaction data entries 210 associated thereto for use in assessing noncompliance based on shared consumers 106 and transaction data.

Table 402 of FIG. 4A illustrates a plurality of transaction data entries 210, such as stored in the transaction database 208. As illustrated in the table, each transaction data entry 210 may include an account identifier 302 associated with a transaction account involved in the related payment transaction, a merchant identifier 304 associated with a merchant involved in the related payment transaction, and a transaction identifier, which may be included in the transaction data 306 and may be a unique value associated with the transaction for identification thereof.

In the example illustrated in FIG. 4A, the receiving unit 202 may receive a request for merchant identifiers for transacting merchants that identifies the identified merchant 104 as being associated with the merchant identifier 1. The processing unit 204 may identify each transaction data entry 210 in the transaction database 208 that includes the merchant identifier 1, and thus involves the identified merchant 104. In the illustrated example, the processing unit 204 may identify those transactions having a transaction identifier of 1, 5, 7, 16, or 17 as involving the identified merchant 104, as illustrated in table 404.

FIG. 4B illustrates the identification of the consumers 106 that have transacted with the identified merchant 104. The processing unit 204 may identify each of the transaction data entries 210 related to payment transactions involving the identified merchant 104 and may identify the account identifiers 302 included therein to identify the associated transaction accounts, and, by extension, the consumers 106 that transact with the identified merchant 104. In the illustrated example, the processing unit 204 may identify that the transaction accounts having account identifiers 1, 4, and 6 have been involved in payment transactions with the identified merchant 104, as illustrated in table 406.

FIG. 4C illustrates the identification of transaction data entries 210 for payment transactions involving the consumers 106 identified in table 406 during the previous step illustrated in FIG. 4B. The processing unit 204 may identify each of the transaction data entries 210 in the transaction database 208 that include the previously identified account identifiers 1, 4, and 6. In the illustrated example, the processing unit 204 may identify the transaction data entries 210 having a transaction identifier of 4, 6, 8, 9, 12, 13, 14, and 15 as involving the transaction accounts with account identifiers of 1, 4, and 6, as illustrated in table 408. In the example illustrated in FIG. 4C, the processing unit 204 does not identify the transaction data entries 210 that involve the transaction accounts associated with account identifiers of 1, 4, and 6 that also involve the identified merchant 104 as the identified merchant 104 does not need to be assessed.

FIG. 4D illustrates the identification of the transacting merchants 110 based on the transaction data entries identified in table 408 during the previous step illustrated in FIG. 4C. The processing unit 204 may identify the merchant identifiers 304 included in each of the transaction data entries 210 in the transaction database 208 that involve the consumers 106 that were also involved in transactions with the identified merchant 104. In the illustrated example, the processing unit 204 may identify the merchant identifiers 2, 3, and 5 being involved in the transactions having transaction identifiers of 4, 6, 8, 9, 12, 13, 14, and 15, as illustrated in table 410. Accordingly, the processing unit 204 may identify merchants being associated with the merchant identifiers 2, 3, and 5 being the transacting merchants 110. The processing unit 204 may then calculate a score for each of the transacting merchants 110 to assess their likelihood of noncompliance.

### Exemplary Method for Assessing Merchant Likelihood of Noncompliance

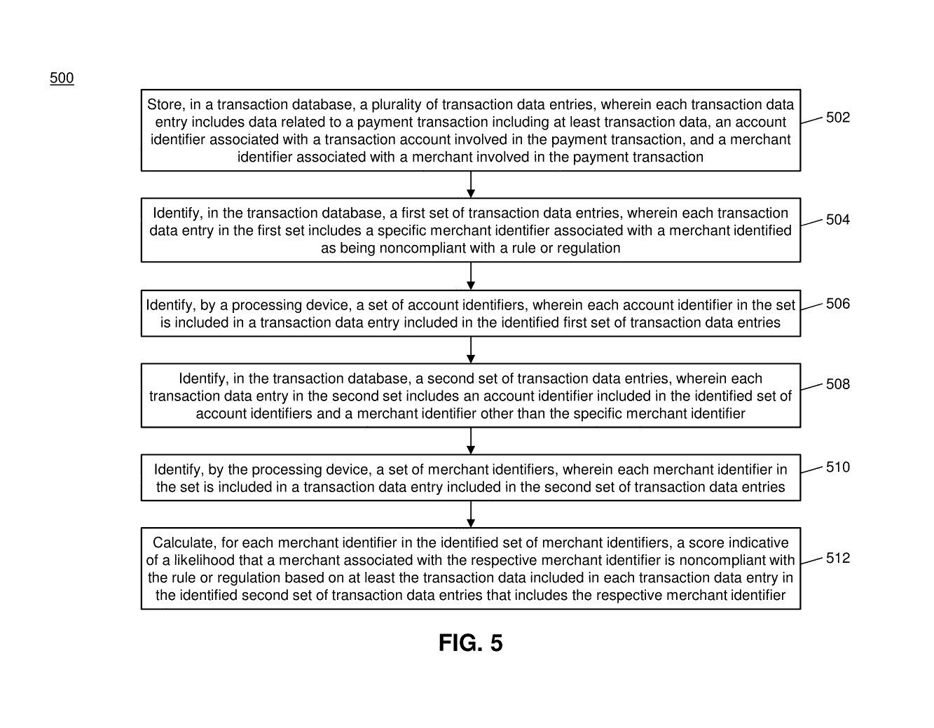

FIG. 5 illustrates a method 500 for the assessing of merchant likelihood of noncompliance based on transacting data and commonality of consumers.

In step 502, a plurality of transaction data entries (e.g., transaction data entries 210) may be stored in a transaction database (e.g., the transaction database 208), wherein each transaction data entry 210 includes data related to a payment transaction including at least transaction data (e.g., transaction data 306), an account identifier (e.g., account identifier 302) associated with a transaction account involved in the payment transaction, and a merchant identifier (e.g., merchant identifier 304) associated with a merchant involved in the payment transaction. In one embodiment, the transaction data may include at least one of: transaction amount, transaction time and/or date, product identifier, product name, product quantity, product amount, geographic location, merchant name, merchant category code, merchant location, industry code, payment method, and payment type.

In step 504, a first set of transaction data entries 210 may be identified in the transaction database 208, wherein each transaction data entry 210 in the first set includes a specific merchant identifier associated with a merchant (e.g., the identified merchant 104) identified as being noncompliant with a rule or regulation. In step 506, a set of account identifiers may be identified, by a processing device (e.g., the processing unit 204), wherein each account identifier in the set is included in a transaction data entry 210 included in the identified first set of transaction data entries 210. In some embodiments, each transaction data entry 210 may further include one or more product identifiers, each product identifier being associated with a product purchased in the related payment transaction, and each account identifier in the identified set of account identifiers may be included in a transaction data entry 210 that includes a specific product identifier.

In step 508, a second set of transaction data entries 210 may be identified in the transaction database 208, wherein each transaction data entry 210 in the second set includes an account identifier 302 included in the identified set of account identifiers and a merchant identifier 304 other than the specific merchant identifier. In step 510, a set of merchant identifiers may be identified by the processing device 204, wherein each merchant identifier in the set is included in a transaction data entry 210 included in the second set of transaction data entries 210. In step 512, a score may be calculated for each merchant identifier in the identified set of merchant identifiers indicative of a likelihood that a merchant (e.g., a transacting merchant 110) associated with the respective merchant identifier is noncompliant with the rule or regulation based on at least the transaction data 306 included in each transaction data entry 210 in the identified second set of transaction data entries 210 that includes the respective merchant identifier.

In one embodiment, the method 500 may further include: transmitting, by a transmitting device (e.g., the transmitting unit 206), the calculated score for each merchant identifier in the identified set of merchant identifiers. In a further embodiment, the method 500 may even further include: receiving, by a receiving device (e.g., the receiving unit 202), wherein the score request includes the specific merchant identifier and where the calculated score for each merchant identifier in the identified set of merchant identifiers is transmitted in response to the received score request.

In some embodiments, the method 500 may also include identifying, by the processing device 204, a filtered set of merchant identifiers, wherein each merchant identifier in the filtered set is included in the identified set of merchant identifiers and wherein the calculated score for each merchant identifier in the filtered set is within a predetermined range of values. In a further embodiment, the method 500 may also include transmitting, by the transmitting device 206, the identified filtered set of merchant identifiers. In an even further embodiment, the method 500 may include receiving, by the receiving device 202, a score request, wherein the score request includes the specific merchant identifier and where the identified filtered set of merchant identifiers is transmitted in response to the received score request. In another further embodiment, transmitting the identified filtered set of merchant identifiers may include transmitting the calculated score corresponding to each merchant identifier included in the filtered set of merchant identifiers.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIG. 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIG. 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for assessing merchant likelihood of noncompliance. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for assessing merchant likelihood of noncompliance, comprising:
storing, in a transaction database, a plurality of transaction data entries, wherein each transaction data entry includes data related to a payment transaction including at least transaction data, an account identifier associated with a transaction account involved in the payment transaction, and a merchant identifier associated with a merchant involved in the payment transaction;
identifying, in the transaction database, a first set of transaction data entries, wherein each transaction data entry in the first set includes a specific merchant identifier associated with a merchant identified as being noncompliant with a rule or regulation;
identifying, by a processing device, a set of account identifiers, wherein each account identifier in the set is included in a transaction data entry included in the identified first set of transaction data entries;
identifying, in the transaction database, a second set of transaction data entries, wherein each transaction data entry in the second set includes an account identifier included in the identified set of account identifiers and a merchant identifier other than the specific merchant identifier;
identifying, by the processing device, a set of merchant identifiers, wherein each merchant identifier in the set is included in a transaction data entry included in the second set of transaction data entries; and
calculating, for each merchant identifier in the identified set of merchant identifiers, a score indicative of a likelihood that a merchant associated with the respective merchant identifier is noncompliant with the rule or regulation based on at least the transaction data included in each transaction data entry in the identified second set of transaction data entries that includes the respective merchant identifier.

2. The method of claim 1, further comprising:
transmitting, by a transmitting device, the calculated score for each merchant identifier in the identified set of merchant identifiers.

3. The method of claim 2, further comprising:
receiving, by a receiving device, a score request, wherein
the score request includes the specific merchant identifier, and
the calculated score for each merchant identifier in the identified set of merchant identifiers is transmitted in response to the received score request.

4. The method of claim 1, further comprising:
identifying, by the processing device, a filtered set of merchant identifiers, wherein each merchant identifier in the filtered set is included in the identified set of merchant identifiers and wherein the calculated score for each merchant identifier in the filtered set is within a predetermined range of values.

5. The method of claim 4, further comprising:
transmitting, by a transmitting device, the identified filtered set of merchant identifiers.

6. The method of claim 5, further comprising:
receiving, by a receiving device, a score request, wherein
the score request includes the specific merchant identifier, and
the identified filtered set of merchant identifiers are transmitted in response to the received score request.

7. The method of claim 5, wherein transmitting the identified filtered set of merchant identifiers includes transmitting the calculated score corresponding to each merchant identifier included in the filtered set of merchant identifiers.

8. The method of claim 1, wherein the transaction data includes at least one of: transaction amount, transaction time and/or date, product identifier, product name, product quantity, product amount, geographic location, merchant name, merchant category code, merchant location, industry code, payment method, and payment type.

9. The method of claim 1, wherein each transaction data entry further includes one or more product identifiers, each product identifier being associated with a product purchased in the related payment transaction.

10. The method of claim 9, wherein each account identifier in the identified set of account identifiers is included in a transaction data entry included in the identified first set of transaction data entries that include a specific product identifier.

11. A system for assessing merchant likelihood of noncompliance, comprising:
a transaction database configured to store a plurality of transaction data entries, wherein each transaction data entry includes data related to a payment transaction including at least transaction data, an account identifier associated with a transaction account involved in the payment transaction, and a merchant identifier associated with a merchant involved in the payment transaction; and
a processing device configured to
identify, in the transaction database, a first set of transaction data entries, wherein each transaction data entry in the first set includes a specific merchant identifier associated with a merchant identified as being noncompliant with a rule or regulation,
identify a set of account identifiers, wherein each account identifier in the set is included in a transaction data entry included in the identified first set of transaction data entries,
identify, in the transaction database, a second set of transaction data entries, wherein each transaction data entry in the second set includes an account identifier included in the identified set of account identifiers and a merchant identifier other than the specific merchant identifier,
identify a set of merchant identifiers, wherein each merchant identifier in the set is included in a transaction data entry included in the second set of transaction data entries, and
calculate, for each merchant identifier in the identified set of merchant identifiers, a score indicative of a likelihood that a merchant associated with the respective merchant identifier is noncompliant with the rule or regulation based on at least the transaction data included in each transaction data entry in the identified second set of transaction data entries that includes the respective merchant identifier.

12. The system of claim 11, further comprising:
a transmitting device configured to transmit the calculated score for each merchant identifier in the identified set of merchant identifiers.

13. The system of claim 12, further comprising:
a receiving device configured to receive a score request, wherein
the score request includes the specific merchant identifier, and
the calculated score for each merchant identifier in the identified set of merchant identifiers is transmitted in response to the received score request.

14. The system of claim 11, wherein the processing device is further configured to identify a filtered set of merchant identifiers, wherein each merchant identifier in the filtered set is included in the identified set of merchant identifiers and wherein the calculated score for each merchant identifier in the filtered set is within a predetermined range of values.

15. The system of claim 14, further comprising:
a transmitting device configured to transmit the identified filtered set of merchant identifiers.

16. The system of claim 15, further comprising:
a receiving device configured to receive a score request, wherein
the score request includes the specific merchant identifier, and
the identified filtered set of merchant identifiers are transmitted in response to the received score request.

17. The system of claim 15, wherein transmitting the identified filtered set of merchant identifiers includes transmitting the calculated score corresponding to each merchant identifier included in the filtered set of merchant identifiers.

18. The system of claim 11, wherein the transaction data includes at least one of: transaction amount, transaction time and/or date, product identifier, product name, product quantity, product amount, geographic location, merchant name, merchant category code, merchant location, industry code, payment method, and payment type.

19. The system of claim 11, wherein each transaction data entry further includes one or more product identifiers, each product identifier being associated with a product purchased in the related payment transaction.

20. The system of claim 19, wherein each account identifier in the identified set of account identifiers is included in a transaction data entry included in the identified first set of transaction data entries that include a specific product identifier.
